(19) United States
(12) Patent Application Publication
(10) Pub. No.: US 2004/0264494 A1
(43) Pub. Date: Dec. 30, 2004

(54) Method and apparatus for transmitting a data frame and a computer program therefor

(76) Inventor: Yeung-Hoi Kim, Yongin-si (KR)

Correspondence Address: HARNESS, DICKEY & PIERCE, P.L.C., P.O. BOX 8910, RESTON, VA, 20195, US

(21) Appl. No.: 10/840,626

(22) Filed: May 7, 2004

(30) Foreign Application Priority Data
Jun. 28, 2003 (KR) 2003-42948

(51) Int. Cl. H04L 12/413

(52) U.S. Cl. 370/448; 370/462

(57) ABSTRACT

A method, apparatus and computer program for transmitting a data frame are described, which may enhance transmission efficiency by transmitting data frames of a plurality of colliding data frames based on a priority of the data frames. For one or more (or all) of a plurality or colliding data frames, a backoff time may be calculated. The calculation of the backoff time may be based on a relative priority of a given data frame as compared to the other colliding data frames. One or more (or all) of the colliding data frames may be transmitted based on the calculated backoff time.

### PRIORITY STATEMENT

This application claims the priority of Korean Patent Application No. 2003-42948, filed on Jun. 28, 2003 in the Korean Intellectual Property Office, the contents of which are herein incorporated by reference in its entirety.

### BACKGROUND OF THE INVENTION

1. Field of the Invention

The present invention relates to an apparatus, method and a computer program for transmitting a data frame.

2. Description of the Related Art

Generally, a typical networking technology for a Local Area Network (LAN) is an Ethernet. The Ethernet has been developed for exchanging information and sharing a system in a restricted area. An Ethernet may provide a signaling speed of 10 Mbps. Thus, computers including an Ethernet card may mutually transmit and receive data. Additionally, the Ethernet card may share the information, and may be externally connected to the Internet.

FIG. 1 is an exemplary diagram of a prior art Ethernet networking configuration. In FIG. 1, for a first user 100-1 to transmit a data to an n-th user 100-n (n representing a natural number), the first user 100-1 may transmit a data frame through a first terminal 110-1. The data frame may be transmitted to a router 140 via a first repeater 120-1 connected to the first terminal 110-1 and through a first switch 130-1. The router 140 may analyze the data frame received, and may transmit the data frame to a second switch 130-2 connected to the n-th terminal 110-n of an nth user 100-n. The second switch 130-2 may transmit the received data frame to the n-th terminal 110-n via an m-th repeater 120-m (m representing a natural number).

When a plurality of data frames are received simultaneously, the router 140, first switch 130-1 and second switch 130-2 may support the quality of service (QoS) so that the data frame with the higher priority may be transmitted first. Subsequent data frames having lower priority may be transmitted thereafter.

QoS may be defined to represent a number of different requirements. In one definition, QoS may be indicative of providing guaranteed performance (e.g., such as a minimum/maximum data network throughput, a minimum delay requirement, a packet loss rate, and/or a packet download time, etc.) in a given network configuration such as an Ethernet of a LAN. An Ethernet may be designed to support several levels of quality of service (QoS) to allow efficient transfer of non real-time traffic (e.g. intermittent and bursty data transfers, occasional transmission of large volumes of data) and real-time traffic (e.g. voice, video).

FIG. 2 is an exemplary block diagram of a prior art switch/router. In FIG. 2, the switch/router may include a plurality of memories 210-1, 210-2, . . . , 210-m that may store the received data frames according to the priority of the data frames, which may be input via ports 200-1, 200-2, . . . , 200-n. Hence, the data frame with the highest priority may be stored in a first memory 210-1, the data frame with the lowest priority may be stored in an m-th memory 210-m, etc. The switch/router may operate in a full duplex mode, in which the plural ports 200-1, 200-2, . . . , 200-n may simultaneously transmit and/or receive data frames.

In a case where several data frames are received simultaneously through the plural ports 200-1, 200-2, . . . , 200-n, the switch/router may store the data frames in memories 210-1, 210-2, . . . , 210-m based on the priority of the received data frame. The stored data frames may be transmitted in decreasing order of priority.

FIG. 3 is an exemplary block diagram of a prior art repeater. In FIG. 3, the repeater may include ports 300-1, 300-2, . . . , 300-n. The ports 300-1, 300-2, . . . , 300-n may receive and/or transmit a data frame. Due to the lack of available memory, the prior art repeater may transmit a received data frame immediately. Additionally, the prior art repeater may operate in a half duplex mode, in which only one port of ports 300-1, 300-2, . . . , 300-n at a time can transmit the data frame. Thus, the priority of the data frames may not be relevant regarding the transmission of the data frame.

FIG. 4 is an exemplary diagram showing an operation of the ports of the repeater in FIG. 3. In FIG. 4, when second data frame DATA 2 and third data frame DATA 3 are input while a first data frame DATA 1 is transmitted through a first port 300-1, second and third ports 300-2 and 300-3 may maintain a waiting state until the transmission of the first data frame DATA 1 is completed. Here, the second data frame DATA 2 may have a relatively higher priority, whereas the third data frame DATA 3 may have a relatively lower priority.

After the transmission of the first data frame DATA 1 is complete, the second port 300-2 may transmit the second data frame DATA 2 and the third port 300-3 may transmit the third data frame DATA 3. Because the prior art repeater cannot transmit data frames simultaneously, a collision may occur in which the data frames collide with one another.

If a collision occurs, the second port 300-2 may transmit the second data frame DATA 2, and the third port 300-3 may transmit the third data frame DATA 3 after a ‘backoff time’ has elapsed. Because the backoff time is defined based on a random value that is irrelevant to the priority of the data frame, the third data frame DATA 3 having the relatively lower priority may be transmitted first, instead of the second data frame DATA 2 having the relatively higher priority, which may be transmitted thereafter.

As mentioned above, because a prior art repeater operates in a half duplex mode, it may not be able to simultaneously transmit the data frames. Thus, if a collision of the data frames occurs, the prior art repeater may transmit the colliding data frame only after a given backoff time (calculated based on the random value) has elapsed. Hence, the prior art repeater may transmit the lower priority data frame first, and then may transmit the higher priority data frame, potentially leading to a degradation in the QoS provided by the Ethernet network to users.

### SUMMARY OF THE INVENTION

An exemplary embodiment of the present invention is directed to a method for transmitting a data frame In the method, for each of a plurality or colliding data frames, a backoff time may be calculated. The calculation of the backoff time may be based on a relative priority of a given data frame as compared to the other colliding data frames. Each of the colliding data frames may be transmitted based on the calculated backoff time.

Another exemplary embodiment of the present invention is directed to an apparatus for transmitting a data frame, in which at least one controller may calculate a backoff time for each of a plurality of colliding data frames. The calculation may be based on a relative priority of a given data frame as compared to the other colliding data frames. Each of the colliding data frames may be transmitted by one or more ports of the apparatus based on the calculated backoff time.

Another exemplary embodiment of the present invention is directed to a computer program product. The computer program product may include a computer-readable medium having computer program logic stored thereon for enabling a processor to transmit data frames. The computer program logic may cause the processor to calculate, for one or more (or all) of a plurality of colliding data frames, a backoff time that is based on a relative priority of a given data frame as compared to the other colliding data frames. The computer program logic may cause the processor to transmit each of the colliding data frames based on the calculated backoff time.

Another exemplary embodiment of the present invention is directed to a computer data signal embodied, for example, in a carrier wave for transmitting a data frame. The computer data signal may include instructions for calculating, for one or more (or all) of a plurality of colliding data frames, a backoff time that is based on a relative priority of a given data frame as compared to the other colliding data frames, and may include instructions for transmitting each of the colliding data frames to a receiving entity based on the calculated backoff time.

### BRIEF DESCRIPTION OF THE DRAWINGS

The present invention will become more apparent to those of ordinary skill in the art by describing, in detail, exemplary embodiments thereof with reference to the attached drawings, wherein like elements are represented by like reference numerals, which are given by way of illustration only and thus do not limit the exemplary embodiments of the present invention.

FIG. 1 is an exemplary diagram of a prior art Ethernet networking configuration.

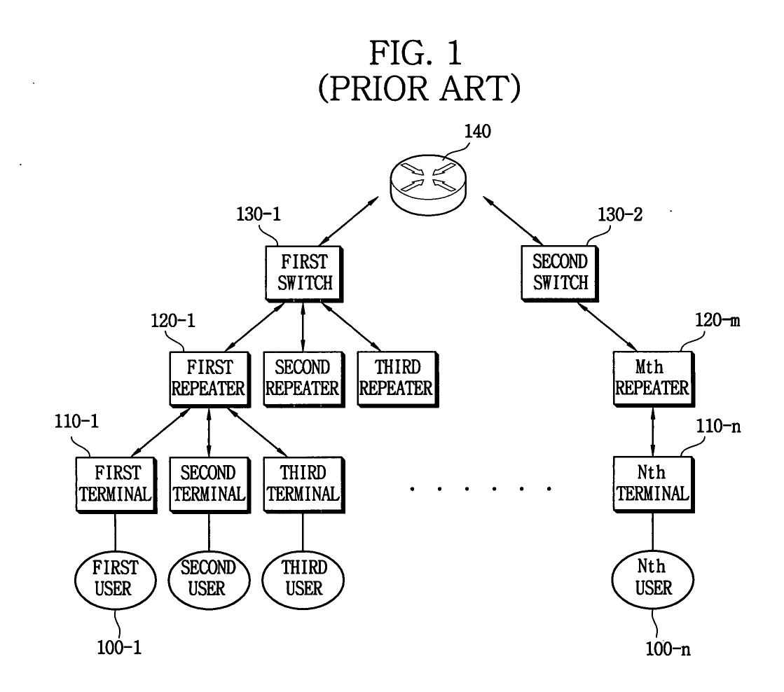

FIG. 2 is an exemplary block diagram of a prior art switch/router.

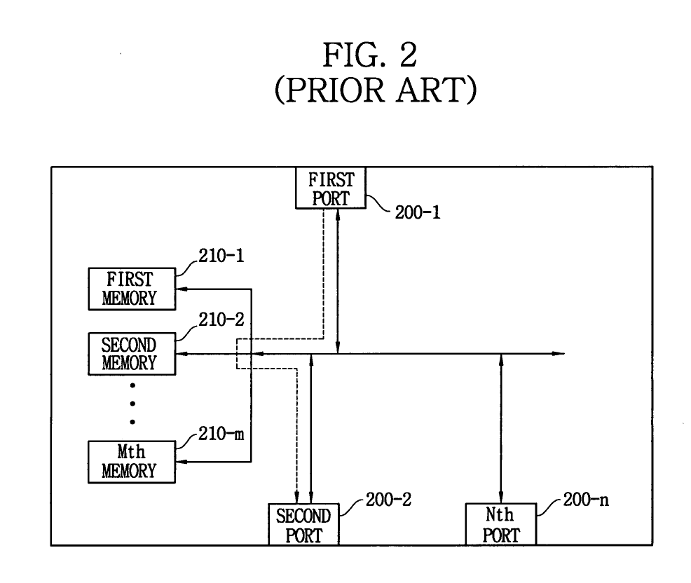

FIG. 3 is an exemplary block diagram of a prior art repeater.

FIG. 4 is an exemplary diagram showing an operation of the ports of the repeater in FIG. 3.

FIG. 5 is an exemplary block diagram of a repeater for an Ethernet network according to an exemplary embodiment of the present invention.

FIG. 6 is an exemplary diagram illustrating an operation of the ports in the repeater of FIG. 5 for a single collision occurrence.

FIG. 7 is an exemplary diagram illustrating an operation of the ports in the repeater of FIG. 5 for two occurrences of the collisions.

FIG. 8 is an exemplary flowchart illustrating a data frame transmission method according to an exemplary embodiment of the present invention.

### DETAILED DESCRIPTION OF THE EXEMPLARY EMBODIMENTS

Hereinafter, exemplary embodiments of the present invention will be described in detail with reference to the accompanying drawings. In general, the exemplary embodiments may be directed to an apparatus, method and computer program for transmitting a data frame which may enhance transmission efficiency of a data frame by transmitting a data frame having a relatively higher priority first.

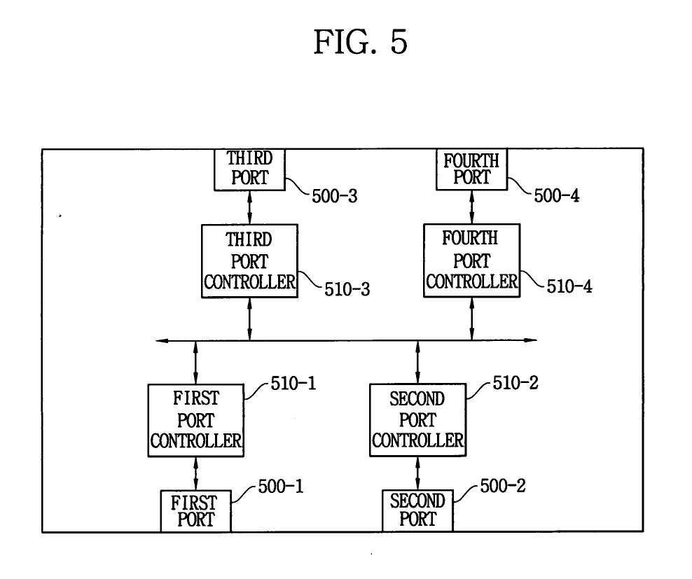

FIG. 5 is a block diagram of a repeater of an Ethernet network according to an exemplary embodiment of the present invention. In reference to FIG. 5, the repeater may include first, second, third and fourth ports 500-1, 500-2, 500-3 and 500-4, although one of ordinary skill in the art could configure the repeater to include fewer or greater than four ports, shown here merely as an exemplary port configuration. Ports 500-1 through 500—may receive a data frame and transmit the data frame received.

The repeater may include corresponding first through fourth port controllers 510-1, 510-2, 510-3 and 510-4, although one of ordinary skill in the art could configure the repeater to include fewer or greater than four port controllers, shown here merely as an exemplary port controller configuration. Port controllers 510-1 through 510-4 may be embodied in hardware and/or software as one or more digital microprocessors that may be provided on the Ethernet card or on a computer including the Ethernet card. However, instead of a digital microprocessor, port controllers 510-1 to 510-4 may also be embodied as an analog processor, digital signal processor and/or one or more application specific integrated circuits controlled by a suitable microcontroller or microprocessor (not shown).

Power may be provided by a suitable AC power source of the computer including the Ethernet card and/or by an embedded battery pack, such a rechargeable secondary battery pack including battery cells having any of a Lithium ion (Li+), nickel cadmium (NiCd) or nickel metal hydride (NiMH) cell chemistry, as known, which provides power to the Ethernet card, for example.

Port controllers 510-1 through 510-4 may control the receiving or transmitting of a given data frame, and may control a collision of the data frame by calculating backoff time for the given data frame. The backoff time may be calculated based on the priority of the data frame, for exampleThe first through fourth port controllers 510-1 to 510-4 may reduce the backoff time if the given data frame has a high or higher priority (relevant to other data frames), and may extend the backoff time if the data frame has a low or lower relative priority. In other words, to calculate the backoff time, a random value may be determined according to the priority of the data frame. Accordingly, the backoff time may be reduced to a degree when the data frame has a high or higher priority relative to other data frames, and extended to a degree when the data frame has a low or lower relative priority. Therefore, the repeater may transmit the high or higher priority data frames first, before transmitting the lower priority data frames.

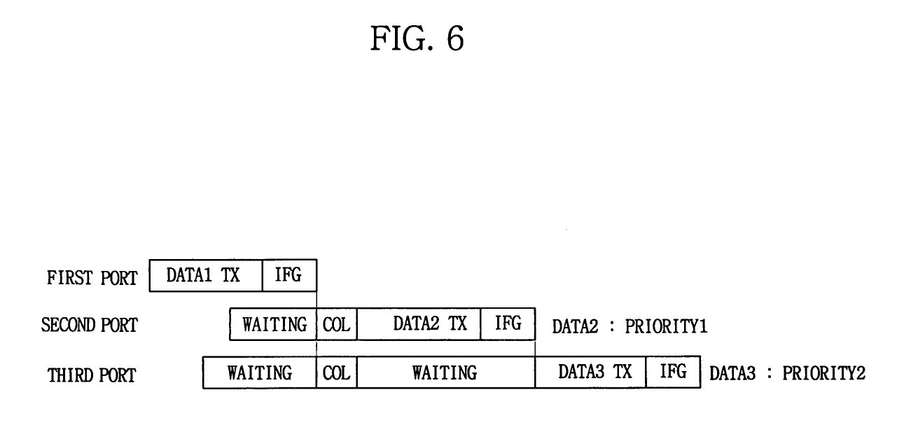

FIG. 6 is an exemplary diagram illustrating an operation of the ports in the repeater of FIG. 5 for a single collision occurrence. Referring to FIG. 6, in a case where a second data frame DATA 2 with a first, highest priority and a third data frame DATA 3 are received while a first data frame DATA 1 is being transmitted through the first port 500-1, the second data frame DATA 2 and the third data frame DATA 3 may collide with each other. The second data frame DATA 2 may be received and/or transmitted through the second port 500-2. The third data frame DATA 3 may be received and/or transmitted through the third port 500-3. When the collision occurs, the second port controller 510-2 and the third port controller 510-3 may calculate respective backoff times for the second and third data frames DATA 2, DATA 3 based on the priority of the respective data frame (DATA 2, DATA 3). It is within the ordinary skill in the art that controllers or processors other than second port controller 510-2 and third port controller 510-3 may perform the backoff time calculations described herein.

In IEEE802.3, which represents the Ethernet network standard, the backoff time may be given by the expression:

Backoff time=r×512 (bit time). (1)

In expression (1), the random value r may be dependent on a priority number (P) of the second data frame DATA 2 and of the third data frame DATA 3, respectively. The priority number P may be set to 1 for a data frame having a highest priority, here DATA 2 in this example. Additionally, the priority number P increases as the priority of a given data decreases; the priority number P may be set to m for a data frame having the lowest priority. Although backoff time may be calculated in accordance with expression (1), it is within the ordinary skill of the art to calculate backoff time based on another parameter or variable or by other expressions than expression (1) above.

In this example, since the second data frame DATA 2 has the higher priority, the calculated backoff time is relatively shorter in comparison with the backoff time calculated for the lower priority e third data frame DATA 3. In other words, the calculated backoff time for the lower priority third data frame DATA 3 is relatively longer in comparison with the backoff time calculated for the second data frame DATA 2.

Hence, the second data frame DATA 2 is transmitted first through the second port 500-2, and third port 500-3 maintains a waiting state during an inter-frame gap (IFG), as shown in FIG. 6. After the IFG has elapsed, the third port 500-3 transmits the third data frame DATA 3.

In a case where the collisions occur twice, r may be set to a value greater than or equal to 0, and less than or equal to 4 (0≦r≦4). In other words, r may be determined according to the priority numbers of data frames that are colliding with one other. In sequence, the data frames may be retransmitted based on the priority of the data frames. Further, in a case where the data frames collide during the subsequent retransmission of the data frames, r may be set to a value greater than or equal to 0, and less than or equal to 4 (0≦r≦4), it being within the ordinary skill of the art to use a range of r values other than the exemplary range (0≦r≦4). Consequently, in this example, the collision occurs twice for data frames having the same priority.

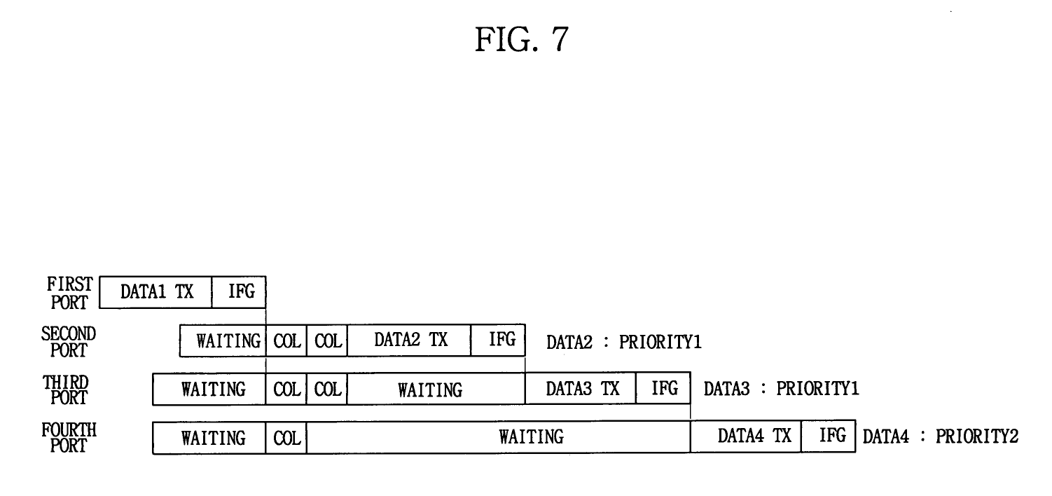

FIG. 7 is an exemplary diagram illustrating an operation of the ports in the repeater of FIG. 5 for two occurrences of the collisions. Referring to FIG. 7, in a case where a second data frame DATA 2 and a third data frame DATA 3 have the same priority (in this example a high or relatively higher priority) and a fourth data frame DATA 4 are received while a first data frame DATA 1 is being transmitted through the first port 500-1, the collisions occur twice.

Since the second data frame DATA 2 and the third data frame DATA 3 have the same priority, either DATA 2 or DATA 3 may be transmitted first.

Therefore, the second port controller 510-2 and the third port controller 510-3 of FIG. 5 calculate the backoff time according to the random value r having a range from 0 to 4. Either of DATA 2 or DATA 3 may be transmitted first through corresponding port 500-2 or 500-3, then the other of DATA 2 and DATA 3 is transmitted next. The fourth data frame DATA 4 with a lower priority then either of DATA 2 or DATA 3 may then be transmitted through the fourth port 500-4.

In a case where the number of collisions is greater than or equal to 3, r may be set in an exemplary range from 0 to 2^{k},i.e., 0≦r≦2^{k}, where k is a value representing a minimum between two values, p and 10. Ranges other than the exemplary range of 0≦r≦2^{k} may be set for collisions greater than three, and other values of k may be selected instead of the exemplary minimum between p and 10, as is evident to one of ordinary skill of the art. Here, p may represent the priority number of the colliding data frame. For a data frame having the highest priority, p=1. Additionally, the priority number p may increase in value with decreasing priority of a given data frame, lower priority data frames having higher p values.

For example, if p is <3, k may be set to 3 so that r has a maximum value of 8. If 4≦p≦9, k may be set to a range from 4 to 9, so that r has a maximum value of 2⁹. If p is greater than 9, k is set to 10, so that r has a maximum value of 2¹⁰. One of ordinary skill of the art may of course set other criteria based on the value of p than described above.

In the case where the number of collisions is greater than or equal to 3, r has the increased maximum value of 2¹⁰ for the data frame having the low priority. The data frame with a high or higher relative priority thus has a shorter backoff time than that of the low or lower priority data frame. Hence, the higher priority data frame is transmitted first, before the low or lower priority data frame. The reason that a collision may occur three or more times is due to data frames having the same backoff time. As discussed above, backoff time may be calculated based on the random value r (priority dependent), where 0≦r≦4 when the collision occurs twice.

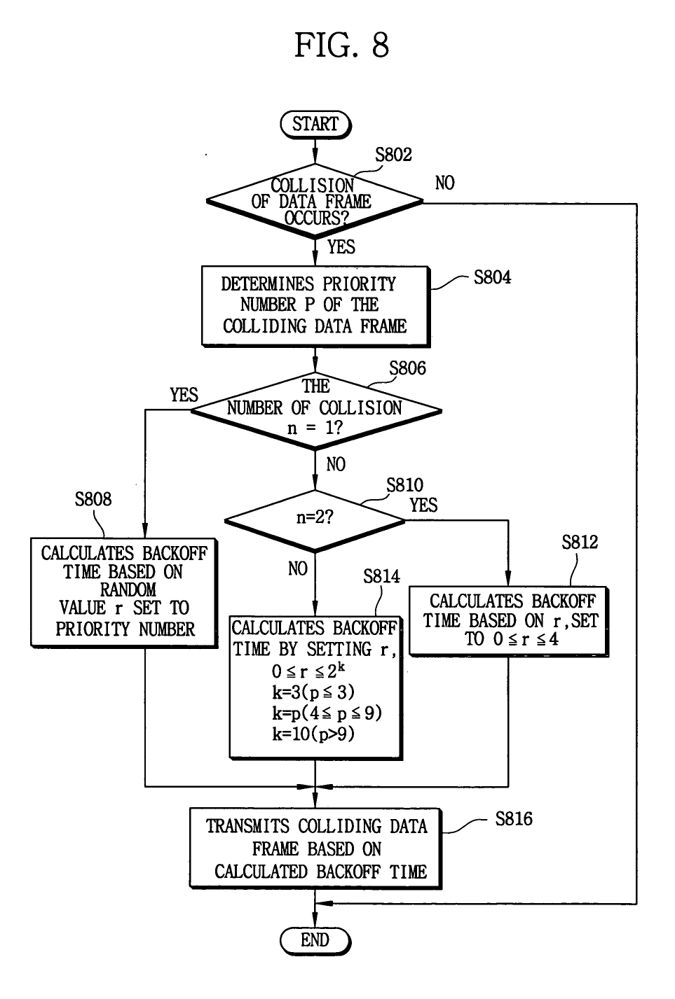

FIG. 8 is an exemplary flowchart illustrating a data frame transmission method in accordance with an exemplary embodiment of the present invention. FIG. 8 illustrates a method that may be performed in a repeater of an Ethernet network configuration that operates in a half duplex mode, for example, other it should be understood that the exemplary method may be implemented in other elements or circuitry than a repeater operating in a half-duplex mode.

Referring to FIG. 8, a given port controller (such as port controllers 510-1 through 510-4 of FIG. 5) may detect whether or not a collision occurs (function S802). If a collision occurs (output of S802 is ‘YES’), the port controller may determine (S804) the priority number p of the colliding data frame. Otherwise, no collision has occurred and the method may be terminated (output of S802 is ‘NO’).

The port controller may determine (S806) whether or not the collision occurs a single time. If a single collision occurs (output of S806 is ‘YES’), the random value r may be set to the priority number p to calculate the backoff time (S808), and the colliding data frames may be transmitted (S816) based on the calculated backoff time.

If more than one collision has occurred (output of S806 is ‘NO’), the port controller may determine (S810) whether or not the collision has occurred twice. If a collision occurs twice (output of S810 is ‘YES’), r may be set within the range from 0 to 4, the backoff time may be calculated (S812), and the colliding data frames may be transmitted (S816) based on the calculated backoff time.

If the number of collisions n is any other value than 2 (output of S810 is ‘NO’), the port controller may determine that the number of collisions is greater than or equal to 3, so the port controller may calculate the backoff time (function S814) by setting r within the range from 0 to 2^{k}, and may transmit (S816) the colliding data frames based on the calculated backoff time. Further, if the priority number p of the data frame is less than or equal to 3, k may be set to 3. If p≧4, and is ≦9, k may be set to p. If p is greater than 9, k may be set to 10, as described above.

Thus, for three or more collisions, r may be set to the maximum value of 2¹⁰ for the data frame having the low or lower priority. The data frame with a high priority may have a shorter backoff time than the lower priority data frame, thus it may be transmitted (S816) before the lower priority data frame.

The exemplary method of FIG. 8 may be embodied in software as a computer program. For example, a program in accordance with the exemplary embodiments of the present invention may be a computer program product causing a computer to execute steps of the exemplary method of data frame transmission. The computer program product may include a computer-readable medium having computer program logic or code portions embodied thereon for enabling a processor, such as a computer including the Ethernet card or a processor controlling one or more of the port controllers in the repeater, for example, to performing the methodology to transmit data frames in accordance with the exemplary method.

The computer-readable storage medium may be a built-in medium installed inside a computer main body or removable medium arranged so that it can be separated from the computer main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory such as memory cards; and media with a built-in ROM, such as ROM cassettes.

The computer program logic may thus cause the processor to perform one or more of S802-S816 of the exemplary data transmission method described herein. Therefore, by causing a computer to execute the program, the data frames may be transmitted by the method. As a result, the quality of service provided by the computer executing the program may be similar to the QoS provided by the exemplary data transmission method.

These programs may also be provided in the form of an externally supplied propagated signal and/or a computer data signal embodied in a carrier wave. The computer data signal embodying one or more instructions or functions of the exemplary methodology may be carried on a carrier wave for transmission and/or reception by an entity that executes the instructions or functions of the exemplary methodology. For example, the functions or instructions of the exemplary embodiments may be implemented by processing one or more code segments of the carrier wave in a computer controlling a given network configuration such as a LAN or in a given Ethernet card of a computer, where instructions or functions are executed to transmit the data frames in accordance with the exemplary data transmission method described herein.

Further, such programs, when recorded on computer-readable storage media, may be readily stored and distributed. The storage medium, as it is read by a computer, may thus enable the transmission of data frames by the exemplary data transmission method described herein.

As described above, the backoff time may be set according to the priority of the data frame in the half duplex mode. Thus, the exemplary embodiments of the present invention may shorten the backoff time of a given data frame with high or relatively higher priority, and may lengthen the backoff time of a given data frame having low or relatively lower priority. The data frame with higher priority may be transmitted before the data frame with lower priority. Accordingly, the exemplary embodiments of the present invention may support QoS requirements of a half duplex mode system, such as the repeater, where it is not possible to simultaneously transmit a plurality of data frames.

Although the exemplary embodiments describe the calculation of backoff time based on a random value that may be determined according to the priority of a given data frame, it is within the skill of the art to calculate backoff time based on another parameter or variable other than priority. Additionally, although FIGS. 6 and 7 have described examples in which a single collision, or two collisions, may occur between data frames, the exemplary embodiments may be applicable to scenarios in which greater than two collisions occur between received data frames.

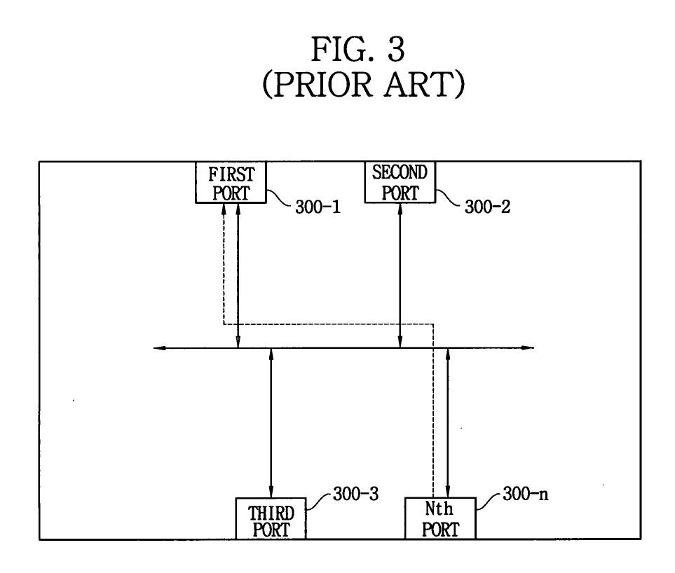

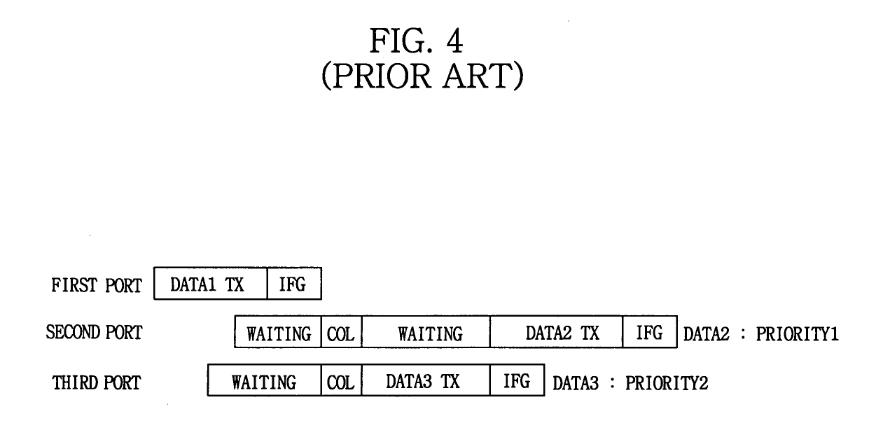

The exemplary embodiments of the present invention being thus described, it will be obvious that the same may be varied in many ways. For example, the functional blocks in FIGS. 3-8 describing the exemplary apparatus and methods may be implemented in hardware and/or software. The hardware/software implementations may include a combination of processor(s) and article(s) of manufacture. The article(s) of manufacture may further include storage media and executable computer program(s). The executable computer program(s) may include the instructions to perform the described operations or functions. The computer executable program(s) may also be provided as part of externally supplied propagated signal(s). Such variations are not to be regarded as departure from the spirit and scope of the exemplary embodiments of the present invention, and all such modifications as would be obvious to one skilled in the art are intended to be included within the scope of the following claims.

What is claimed is:

1. A method for transmitting a data frame, comprising:
detecting whether or not a collision of a plurality of received data frames occurs;
determining a priority of thedata frames colliding with each other;
calculating a backoff time according to the priority; and
transmitting the data frames colliding with each other, the data frames being transmitted based on the calculated backoff time.

2. The method of claim 1, wherein calculating the backoff time includes calculating the backoff time based on at least one priority of the data frame and a number of collisions of the data frame.

3. The method of claim 2, wherein the backoff time is given by an expression:
Backoff time=r×512 (bit number),
wherein r is determined by the number of collisions and the priority of the data frame.

4. The method of claim 3, wherein
r is a priority number of the data frame, the priority number increasing as the priority decreases, if the number of collisions of the data frame is 1.

5. The method of claim 4, wherein thecolliding data frames each have a different priority number.

6. The method of claim 3, wherein r has a random value, if the number of collisions of the data frame equals 2.

7. The method of claim 6, wherein the data frames colliding with each other have the same priority number.

8. The method of claim 7, wherein r is greater than or equal to 0, and less than or equal to 4.

9. The method of claim 3, wherein, if the number of collisions of the data frame is equal to or exceeds 3,
r is in a range from 0 to 2^{k},
k is equal to 3 if the priority number of the data frame is less than or equal to 3,
k equals the priority number of the data frame if the priority number of the data frame is greater than or equal to 4 and less than or equal to 9,
k equals 10 if the priority number of the data frame is greater than 9, and
a priority number of 1 represents a highest priority of the data frame, the priority number increasing as the priority of the data frame decreases.

10. An apparatus for transmitting a data frame, comprising:
means for detecting whether or not a collision of a plurality of received data frames has occurred;
means for determining a priority of the data frames colliding with each other;
means for calculating backoff time according to the priority for each data frame; and
means for transmitting the colliding data frames based on the calculated backoff time.

11. The apparatus of claim 10, wherein the means for calculating a backoff time calculates the backoff time based on at least one priority of the data frame and a number of collisions of the data frame.

12. The apparatus of claim 11, wherein the backoff time is given by an expression:
Backoff time=r×512(bit number),
wherein r is determined based on the number of collisions and the priority of the data frame.

13. The apparatus of claim 12, wherein r is a priority number of the data frame and the priority number increases as the priority of the data frame decreases, if the number of collisions is 1.

14. The apparatus of claim 12, wherein r has a random value if the number of collisions equals 2.

15. The apparatus of claim 14, wherein r is greater than or equal to 0, and is less than or equal to 4.

16. The apparatus of claim 12, wherein, if the number of collisions of the data frame is equal to or exceeds 3,
r is in a range from 0 to 2^{k,}
k is equal to 3 if the priority number of the data frame is less than or equal to 3,
k equals the priority number of the data frame if the priority number of the data frame is greater than or equal to 4 and less than or equal to 9,
k equals 10 if the priority number of the data frame is greater than 9, and
a priority number of 1 represents a highest priority of the data frame,
the priority number increasing as the priority of the data frame decreases.

17. A method for transmitting data frames, comprising:
calculating for each of a plurality of colliding data frames, a backoff time that is based on a relative priority of a given data frame as compared to the other colliding data frames; and
transmitting each of the colliding data frames based on the calculated backoff time.

18. An apparatus for transmitting data frames, comprising:
at least one controller for calculating, for each of a plurality of colliding data frames, a backoff time that that is based on a relative priority of a given data frame as compared to the other colliding data frames; and
at least one port for transmitting each of the colliding data frames based on the calculated backoff time.

19. A computer program product comprising a computer-readable medium having computer program logic stored thereon for enabling a processor to transmit one or more data frames, the computer program logic causing the processor to perform the functions of:
detecting whether or not a collision of a plurality of received data frames occurs;
determining a priority for data frames colliding with each other;
calculating a backoff time according to the priority; and
transmitting the data frames colliding with each other, the data frames being transmitted based on the calculated backoff time.

20. A computer program product comprising a computer-readable medium having computer program logic stored thereon for enabling a processor to transmit one or more data frames, the computer program logic causing the processor to perform the functions of:
calculating, for each of a plurality of colliding data frames, a backoff time that is based on a relative priority of a given data frame as compared to the other colliding data frames; and
transmitting each of the colliding data frames based on the calculated backoff time.

21. A program, adapted to cause a computer to execute the method of claim 1.

22. A program, adapted to cause a computer to execute the method of claim 17.

23. A computer-readable storage medium, on which is recorded a program adapted to cause a computer to execute the method of claim 1.

24. A computer-readable storage medium, on which is recorded a program adapted to cause a computer to execute the method of claim 17.

25. A computer data signal embodied in a carrier wave, the computer data signal comprising
a first code segment for detecting whether or not a collision of a plurality of received data frames occurrs;
a second code segment for determining a priority for data frames colliding with each other;
a third code segment for calculating a backoff time according to the priority; and
a fourth code segment for transmitting the data frames colliding with each other to a receiving entity, the data frames being transmitted based on the calculated backoff time.

26. A computer data signal embodied in a carrier wave, comprising
instructions for calculating, for each of a plurality of colliding data frames, a backoff time that is based on a relative priority of a given data frame as compared to the other colliding data frames; and
instructions for transmitting each of the colliding data frames to a receiving entity based on the calculated backoff time.

27. An apparatus for transmitting data frames in accordance with the method of claim 1.

28. An apparatus for transmitting data frames in accordance with the method of claim 17.
